(19) United States
(12) Patent Application Publication
(10) Pub. No.: US 2026/0027719 A1
(43) Pub. Date: Jan. 29, 2026

(54) ROBOT CONTROL SYSTEM, ROBOT CONTROL APPARATUS, AND CONTROL METHOD

(71) Applicant: SEIKO EPSON CORPORATION, Tokyo (JP)

(72) Inventor: Dai TANAKA, MATSUMOTO-SHI (JP)

(21) Appl. No.: 19/275,844

(22) Filed: Jul. 21, 2025

(30) Foreign Application Priority Data
Jul. 24, 2024 (JP) 2024-118850

(51) Int. Cl. B25J 9/16

(52) U.S. Cl. CPC B25J 9/1679; B25J 9/1653; B25J 9/1674

(57) ABSTRACT

There is provided a robot control apparatus including: an opening/closing signal acquisition section that acquires an opening/closing signal; a trigger signal acquisition section that acquires a trigger signal; and a determination section that defines, as a safety confirmation state, a case where, when power is supplied to the robot control apparatus, an opening/closing detection section detects that the closed state is achieved based on an opening/closing signal acquired by the opening/closing signal acquisition section, and the trigger signal acquisition section acquires the trigger signal, and determines whether or not the safety confirmation state is achieved, in which the robot control apparatus permits an operation of the robot arm when the determination section determines that the safety confirmation state is achieved, and prohibits an operation of the robot arm when the determination section determines that the safety confirmation state is not achieved.

### CROSS-REFERENCE TO RELATED APPLICATIONS

The present application is based on, and claims priority from JP Application Serial Number 2024-118850, filed Jul. 24, 2024, the disclosure of which is hereby incorporated by reference herein in its entirety.

### BACKGROUND OF THE INVENTION

### 1. Technical Field

The present disclosure relates to a robot control system, a robot control apparatus, and a control method.

### 2. Related Art

In recent years, in a factory, due to the increase in labor costs and labor shortages, work such as transport, manufacturing, processing, assembly, and inspection of a workpiece such as a machine part is performed by a robot system, and automation of work that was performed manually is progressing. Such robot systems require high levels of safety, and various measures are taken to ensure this.

For example, JP-A-2009-190103 discloses a semiconductor transport apparatus including a robot that transports a semiconductor and a casing that houses the robot. The casing has an opening portion for accessing the inside and a cover that is an opening/closing door for opening and closing the opening portion. In this robot system, when the cover is in the open state in a state where the power supply is in the ON state, the interlock operates, and the operation of the robot is stopped without a predetermined release operation. As a result, a human body or the like can be prevented from entering the casing from the opening portion and coming into contact with the robot during the operation, and the safety can be enhanced.

However, in the semiconductor transport apparatus of JP-A-2009-190103, the configuration is not such that the interlock operates when the power supply is turned from OFF to ON, and there is a risk that the robot may operate even when the cover is open when the power supply is turned ON. Moreover, even when the interlock is merely operated when the power supply is turned ON, it is difficult to say that high safety is ensured.

### SUMMARY OF THE INVENTION

According to an aspect of the present disclosure, there is provided a robot control system including: an opening/closing section that opens or closes an access section configured to access a movable region of a robot having a robot arm; an opening/closing detection section that detects an open state or a closed state of the opening/closing section; an opening/closing signal transmission section that transmits an opening/closing signal including information on the open/closed state detected by the opening/closing detection section; and a robot control apparatus that outputs a drive signal to the robot and controls an operation of the robot, in which the robot control apparatus includes an opening/closing signal acquisition section that acquires the opening/closing signal, a trigger signal acquisition section that acquires a trigger signal, and a determination section that defines, as a safety confirmation state, a case where, when power is supplied to the robot control apparatus, the opening/closing detection section detects that the closed state is achieved based on the opening/closing signal acquired by the opening/closing signal acquisition section, and the trigger signal acquisition section acquires the trigger signal, and determines whether or not the safety confirmation state is achieved, and the robot control apparatus permits an operation of the robot arm when the determination section determines that the safety confirmation state is achieved, and prohibits an operation of the robot arm when the determination section determines that the safety confirmation state is not achieved.

According to another aspect of the present disclosure, there is provided a robot control apparatus that outputs a drive signal to a robot having a robot arm and controls an operation of the robot, the robot control apparatus including: an opening/closing signal acquisition section that acquires an opening/closing signal including information on an open/closed state of an opening/closing section that opens or closes an access section configured to access a movable region of the robot; a trigger signal acquisition section that acquires a trigger signal; and a determination section that defines, as a safety confirmation state, a case where, when power is supplied to the robot control apparatus, an opening/closing detection section detects that the closed state is achieved based on the opening/closing signal acquired by the opening/closing signal acquisition section, and the trigger signal acquisition section acquires the trigger signal, and determines whether or not the safety confirmation state is achieved, in which an operation of the robot arm is permitted when the determination section determines that the safety confirmation state is achieved, and an operation of the robot arm is prohibited when the determination section determines that the safety confirmation state is not achieved.

According to still another aspect of the present disclosure, there is provided a control method of a robot control apparatus that includes an opening/closing signal acquisition section that acquires an opening/closing signal including information on an open/closed state of an opening/closing section that opens or closes an access section configured to access a movable region of a robot having a robot arm, and a trigger signal acquisition section that acquires a trigger signal, and that outputs a drive signal to the robot to control an operation of the robot, the method including: a first step of defining, as a safety confirmation state, a case where, when power is supplied to the robot control apparatus, an opening/closing detection section detects that the closed state is achieved based on the opening/closing signal acquired by the opening/closing signal acquisition section, and the trigger signal acquisition section acquires the trigger signal, and determining whether or not the safety confirmation state is achieved; and a second step of permitting an operation of the robot arm when it is determined that the safety confirmation state is achieved, and prohibiting an operation of the robot arm when it is determined that the safety confirmation state is not achieved in the first step.

### BRIEF DESCRIPTION OF DRAWINGS

FIG. 1 is a schematic configuration diagram of a robot system including a robot control system according to a first embodiment of the present disclosure.

FIG. 2 is a block diagram of the robot system illustrated in FIG. 1.

FIG. 3 is a block diagram illustrating a hardware configuration example of the robot system illustrated in FIG. 1.

FIG. 4 is a plan view of a notification section included in a robot control apparatus illustrated in FIG. 1.

FIG. 5 is a flowchart for describing an example of a control method according to the first embodiment of the present disclosure.

FIG. 6 is a flowchart for describing an example of a control method according to a second embodiment of the present disclosure.

FIG. 7 is a schematic configuration diagram of a robot system including a robot control system according to a third embodiment of the present disclosure.

FIG. 8 is a flowchart for describing an example of a control method according to the third embodiment of the present disclosure.

FIG. 9 is a flowchart for describing an example of a control method according to a fourth embodiment of the present disclosure.

### DETAILED DESCRIPTION OF THE INVENTION

### First Embodiment

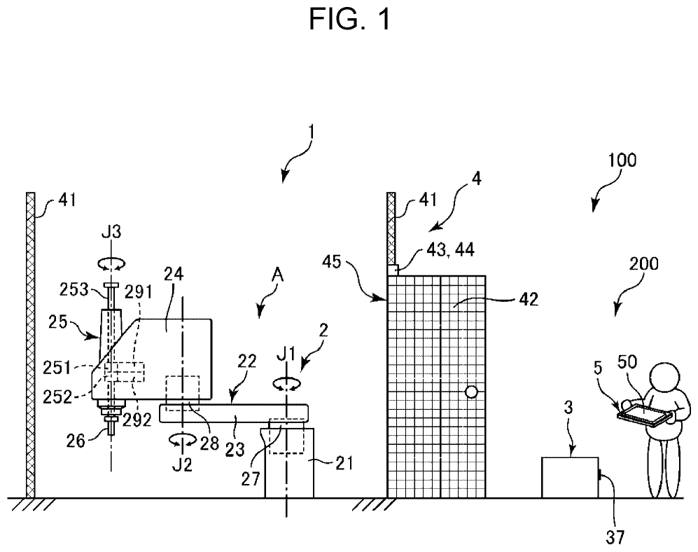

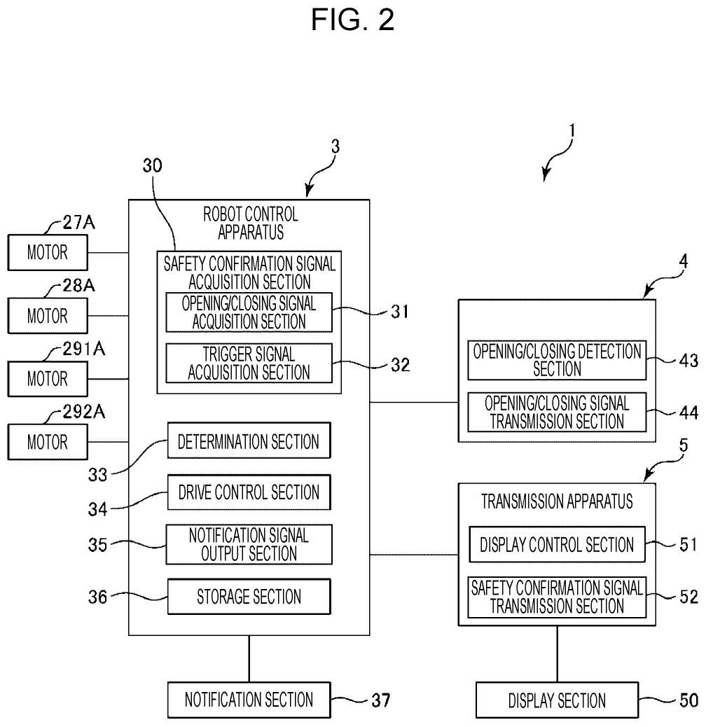

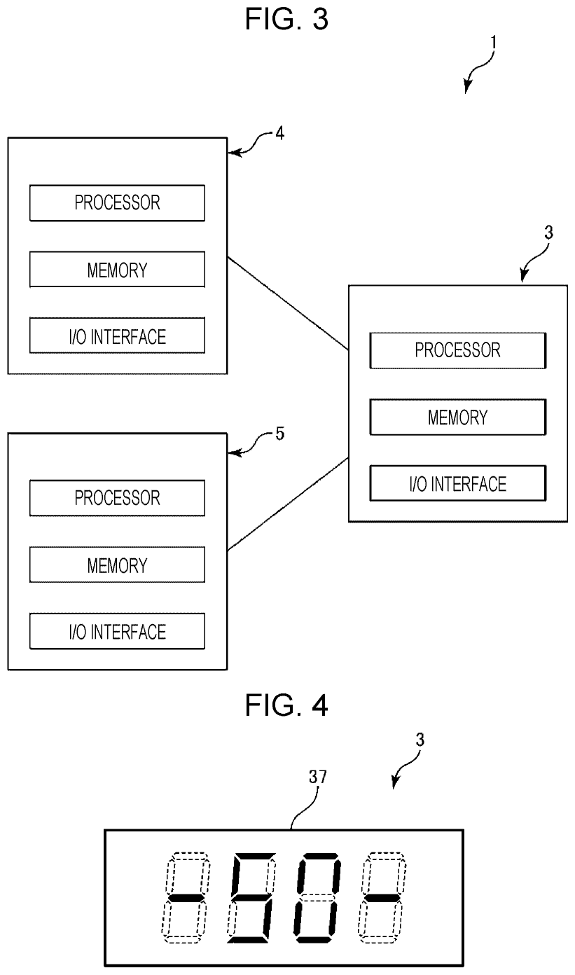

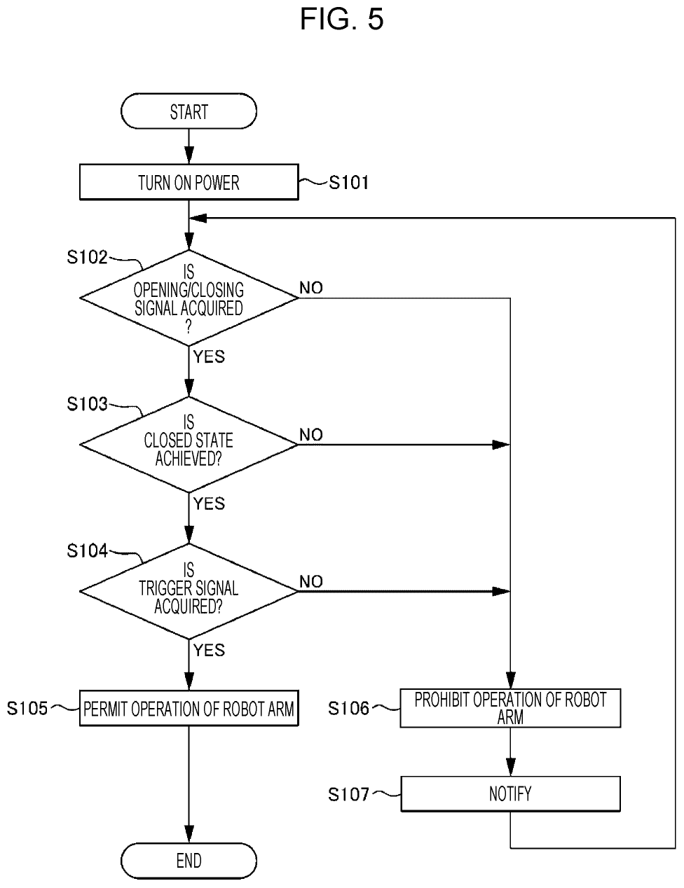

FIG. 1 is a schematic configuration diagram of a robot system including a robot control system according to a first embodiment of the present disclosure. FIG. 2 is a block diagram of the robot system illustrated in FIG. 1. FIG. 3 is a block diagram illustrating a hardware configuration example of the robot system illustrated in FIG. 1. FIG. 4 is a plan view of a notification section included in the robot control apparatus illustrated in FIG. 1. FIG. 5 is a flowchart for describing an example of a control method according to the first embodiment of the present disclosure.

Hereinafter, a robot control system, a robot control apparatus, and a control method of the present disclosure will be described in detail based on preferred embodiments illustrated in the accompanying drawings.

In the following, for convenience of description, regarding the robot arm, a side of a base 21 in FIG. 1 is referred to as a “base end”, and the opposite side, that is, an end effector 26 side is referred to as a “tip end”.

As illustrated in FIG. 1, the robot system 1 is a system that executes a control method of the present disclosure, and includes a robot 2, a robot control apparatus 3 which is an example of the robot control apparatus of the present disclosure, a safety fence system 4, and a transmission apparatus 5. A robot control system 100 which is an example of the robot control system of the present disclosure is configured by the robot control apparatus 3 and the safety fence system 4. Further, the control system 200 is configured by the robot control apparatus 3 and the transmission apparatus 5.

First, the robot 2 will be described.

As illustrated in FIG. 1, the robot 2 is a SCARA robot, and drives a robot arm 22 in a desired operation, and performs work such as transport, assembly, and inspection of a workpiece such as an electronic component, or various work such as processing and painting on the workpiece by a tool (hereinafter these are collectively referred to as “work”). However, the application of the robot 2 is not particularly limited. In addition, the robot 2 according to the present disclosure may be a robot other than the SCARA robot, for example, a 6-axis multi-joint robot, an orthogonal robot in which a linear slider is combined, a dual-arm robot, or the like.

As illustrated in FIG. 1, the robot 2 includes the base 21 which is a base portion, and the robot arm 22 which is rotatably coupled to the base 21. The base 21 is fixed to a floor surface parallel to a horizontal plane.

The robot arm 22 includes a first arm 23 of which the base end portion is coupled to the base 21 and rotates around a first rotation axis J1 along the vertical direction with respect to the base 21, and a second arm 24 of which the base end portion is coupled to the tip end portion of the first arm 23 and rotates around a second rotation axis J2 along the vertical direction with respect to the first arm 23.

A working head 25 is provided at the tip end portion of the second arm 24. The working head 25 includes a spline nut 251 and a ball screw nut 252 coaxially disposed at the tip end portion of the second arm 24, and a spline shaft 253 inserted into the spline nut 251 and the ball screw nut 252. The spline shaft 253 is rotatable around a third rotation axis J3 along the central axis in the vertical direction with respect to the second arm 24, and is movable up and down along the third rotation axis J3.

The end effector 26 is mounted on the lower end portion of the spline shaft 253. The end effector 26 is detachable, and the end effector 26 suitable for the work is appropriately selected. Examples of the end effector 26 include those that can hold a workpiece or a tool.

The robot 2 includes a first joint actuator 27 that couples the base 21 and the first arm 23 and rotates the first arm 23 around the first rotation axis J1 with respect to the base 21, and a second joint actuator 28 that couples the first arm 23 and the second arm 24 and rotates the second arm 24 around the second rotation axis J2 with respect to the first arm 23.

The robot 2 includes a first driving mechanism 291 that rotates the spline shaft 253 around the third rotation axis J3 by rotating the spline nut 251, and a second driving mechanism 292 that raises and lowers the spline shaft 253 in the direction along the third rotation axis J3 by rotating the ball screw nut 252.

The first joint actuator 27 includes a motor 27A as a first motor, a speed reducer (not illustrated), an encoder, and the like. The second joint actuator 28 includes a motor 28A as a second motor, a speed reducer (not illustrated), an encoder, and the like. The first driving mechanism 291 includes a motor 291A, a speed reducer (not illustrated), an encoder, and the like. The second driving mechanism 292 includes a motor 292A, a speed reducer (not illustrated), an encoder, and the like.

As illustrated in FIG. 2, the motor 27A, the motor 28A, the motor 291A, and the motor 292A are electrically coupled to the robot control apparatus 3 via a motor driver (not illustrated) respectively. The robot control apparatus 3 controls power-on conditions, that is, power-on amount, power-on timing, and the like from a power supply (not illustrated) to each of the motor 27A, the motor 28A, the motor 291A, and the motor 292A via each motor driver. As a result, the operation of the robot arm 22 can be controlled to change each arm to a desired posture.

Each encoder is electrically coupled to the robot control apparatus 3. Each encoder detects the rotation position information of the corresponding motor and transmits the rotation position information to the robot control apparatus 3. The robot control apparatus 3 controls the power-on conditions to the motor 27A, the motor 28A, the motor 291A, and the motor 292A based on the rotation position information of each motor received from each encoder. By recognizing the rotation positions of each of the motor 27A, the motor 28A, the motor 291A, and the motor 292A, a predetermined operation can be accurately performed by controlling the operation of the robot arm 22.

Next, the safety fence system 4 will be described.

As illustrated in FIGS. 1 and 2, the safety fence system 4 includes a safety fence 41, an opening/closing door 42, an opening/closing detection section 43, and an opening/closing signal transmission section 44.

The safety fence 41 is provided around the robot 2 to surround a movable region A of the robot 2. As a result, other objects such as a person or an obstacle can be prevented from unintentionally entering the movable region A or approaching the robot 2 during the operation of the robot 2, and thus the safety can be ensured. The movable region A of the robot 2 is a space including a space in which the robot 2, particularly, the robot arm 22 can move and the periphery of the space. The movable region A varies depending on the type of the robot 2.

A part of the safety fence 41 is configured with an opening through which an operator or the like can enter and exit, and an access section 45 for accessing the movable region A of the robot 2 is provided. The access section 45 is provided with an opening/closing door 42 as an opening/closing section that opens or closes the access section 45. When the opening/closing door 42 is in the fully open state (hereinafter referred to as the “open state”), the operator can enter the inside of the safety fence 41 via the access section 45 and can perform work such as installation, replacement, and removal of the work object (workpiece) by the robot 2, and maintenance of the robot 2. Meanwhile, when the opening/closing door 42 is in the fully closed state (hereinafter referred to as the “closed state”), the operator or the like can be prevented from entering and exiting via the access section 45. The opening/closing door 42 is in the open state when the opening/closing door 42 is in a state other than the completely closed state (fully closed state), for example, in a half-open state.

The opening/closing detection section 43 is provided in the vicinity of the opening/closing door 42 and detects the open state or the closed state of the opening/closing door 42. The opening/closing detection section 43 generates information on the detected open state or closed state, that is, information on the open/closed state, and outputs the information to the opening/closing signal transmission section 44.

The detection method of the opening/closing detection section 43 is not particularly limited, and examples thereof include an optical type, a contact type, a capacitance type, and the like.

The opening/closing signal transmission section 44 converts the information on the open/closed state output by the opening/closing detection section 43 into an electric signal and transmits the electric signal to the robot control apparatus 3. Hereinafter the signal including the information on the open/closed state transmitted by the opening/closing signal transmission section 44 is referred to as an opening/closing signal. That is, the opening/closing signal includes information on the open state or the closed state of the opening/closing door 42. Here, the opening/closing signal is not particularly limited, and may be, for example, an electric signal having a voltage value that differs between a case where the opening/closing door 42 is in the closed state and a case where the opening/closing door 42 is in the open state. In this case, the opening/closing signal transmission section 44 and the robot control apparatus 3 are electrically coupled to each other, and the voltage value of the electric signal transmitted from the opening/closing signal transmission section 44 to the robot control apparatus 3 can be monitored to determine whether the opening/closing door 42 is in the open state or the closed state.

In such a safety fence system 4, the robot 2 may be operated when the opening/closing door 42 is in the closed state from the viewpoint of improving safety.

As illustrated in FIGS. 1 and 2, the transmission apparatus 5 is an apparatus that transmits a safety confirmation signal, which is an example of a trigger signal, to the robot control apparatus 3. When the operator visually confirms or touches the opening/closing door 42 by hand or the like to confirm that the opening/closing door 42 is in the closed state (hereinafter referred to as “safety confirmation”), the operator inputs the fact that the safety confirmation is completed to the transmission apparatus 5, and the transmission apparatus 5 transmits a safety confirmation signal to the robot control apparatus 3.

The transmission apparatus 5 includes a display section 50, and a display control section 51 and a safety confirmation signal transmission section 52 as functional sections. In the present embodiment, the transmission apparatus 5 is a tablet terminal that is an apparatus having the display section 50. However, the present disclosure is not limited to this configuration, and the transmission apparatus 5 may be a notebook personal computer, a desktop personal computer, a teaching pendant, a smartphone, or the like, or may be built in any of these. Further, as will be described later, the transmission apparatus 5 only needs to be able to receive an input indicating that the operator performed safety confirmation, and may be a button that does not include the display section 50.

The display section 50 is a display configured with a touch panel. The operator can perform an input operation of various information such as a safety confirmation described later and a transmission instruction operation of a safety confirmation signal by viewing an image displayed on the display section 50 or performing a desired touch operation with his or her own finger or a touch pen.

Although not illustrated, the display section 50 displays a safety confirmation input screen in which the operator inputs that the safety confirmation is performed. For example, a safety confirmation completion button (not illustrated) is displayed on the safety confirmation input screen, and the operator inputs that the safety confirmation is completed by pressing the safety confirmation completion button. The safety confirmation performed by the operator is to be confirmed by, for example, visually confirming that the opening/closing door 42 is in the closed state or to be confirmed by touching the opening/closing door 42 by hand (hereinafter referred to as “visually confirming”) when starting the operation of the robot 2.

The display section 50 is configured by, for example, a display panel in which a liquid crystal element, an organic EL element, or the like is arranged in a planar shape, and has, in addition to a display function of information, for example, a touch operation function (input function). The display section 50 can display a display screen and an operation screen in color or monochrome, respectively. In addition, as the type of the touch panel in the display section 50, either a pressure-sensitive type or a capacitance type may be used.

The display control section 51 controls the operation of the display section 50 to display a screen displayed on the display section 50, for example, a safety confirmation input screen or the like.

The safety confirmation signal transmission section 52 acquires a signal indicating that the safety confirmation is performed, that is, a safety confirmation signal, which is input from the safety confirmation input screen, and transmits the safety confirmation signal to the robot control apparatus 3. The transmission of the safety confirmation signal may be automatically performed after the input on the safety confirmation input screen, or may be performed by the operator performing a transmission instruction operation of the safety confirmation signal on the display section 50.

As illustrated in FIG. 1, the robot control apparatus 3 is installed outside the safety fence 41. However, the configuration is not limited to this, and the robot control apparatus 3 may be installed inside the safety fence 41.

As illustrated in FIG. 2, the robot control apparatus 3 has a safety confirmation signal acquisition section 30, a determination section 33, a drive control section 34, a notification signal output section 35, a storage section 36, and a notification section 37 as functional sections.

The robot control apparatus 3 is provided with a power switch (not illustrated), which is turned on and off by an operator. In a state where the power switch is ON, power is supplied from the external power supply to the robot control apparatus 3, power can be supplied to each section of the robot 2, and a drive signal can be output to the robot 2. Meanwhile, in a state where the power switch is OFF, power is not supplied from the external power supply to each section of the robot control apparatus 3 and the robot 2, and the robot control apparatus 3 cannot operate the robot 2.

The safety confirmation signal acquisition section 30 has an opening/closing signal acquisition section 31 and a trigger signal acquisition section 32.

The opening/closing signal acquisition section 31 acquires the opening/closing signal transmitted by the opening/closing signal transmission section 44 of the safety fence system 4 and stores the opening/closing signal in the storage section 36.

The trigger signal acquisition section 32 acquires the safety confirmation signal transmitted by the safety confirmation signal transmission section 52. The information on the safety confirmation signal acquired by the trigger signal acquisition section 32 is stored in the storage section 36.

The determination section 33 determines whether or not the safety confirmation state is achieved when the power is supplied to the robot control apparatus 3, that is, when the power switch (not illustrated) of the robot control apparatus 3 is turned on. The safety confirmation state is a state where the following conditions (1) and (2) are satisfied.

Condition (1): The opening/closing detection section 43 detects that the closed state is achieved based on the opening/closing signal acquired by the opening/closing signal acquisition section 31. The fact that the condition (1) is satisfied means that the opening/closing detection section 43 detects that the opening/closing door 42 is in the closed state.

In addition, in the determination of the condition (1), the configuration is not limited to the above configuration, and for example, the robot control apparatus 3 may determine that the opening/closing door 42 is in the closed state based on the opening/closing signal acquired by the opening/closing signal acquisition section 31.

Condition (2): The trigger signal acquisition section 32 acquired the safety confirmation signal (trigger signal). The fact that the condition (2) is satisfied means that the operator, for example, visually confirms that the opening/closing door 42 is in the closed state, inputs the fact, and transmits the fact.

The determination section 33 determines that the “safety confirmation state” is achieved when both the conditions (1) and (2) are satisfied, and determines that the “safety unconfirmed state” is achieved when at least one of the conditions (1) and (2) is not satisfied.

The determination result of the determination section 33 is transmitted to the drive control section 34. That is, the information on whether the safety confirmation state or the safety unconfirmed state is achieved is transmitted to the drive control section 34.

Supplying power to the robot control apparatus 3 includes switching from an OFF state to an ON state of the power supply and switching the robot control apparatus 3 from a sleep state (low power state) to a normal startup state.

The drive control section 34 permits the operation of the robot arm 22 when the determination section 33 determines that the safety confirmation state is achieved. That is, in a case where the determination section 33 determines that the safety confirmation state is achieved, the drive control section 34 reads out and executes various operation programs stored in the storage section 36, for example, when the drive control section 34 receives an operation start instruction by a touch operation on the display section 50 by the operator. The drive signal generated by the drive control section 34 is transmitted to each section of the robot 2. As a result, the robot arm 22 can safely execute a predetermined operation (work) under predetermined conditions.

Meanwhile, the drive control section 34 prohibits the operation of the robot arm 22 when the determination section 33 determines that the safety confirmation state is not achieved, that is, the safety unconfirmed state is achieved. In other words, when the determination section 33 determines that the safety confirmation state is not achieved, the drive control section 34 does not transmit the drive signal to each section of the robot 2 regardless of the presence or absence of the operation start instruction by the operator, and does not operate the robot 2.

As described above, when the power switch is turned on, the robot control apparatus 3 permits the operation of the robot arm 22 only when both the conditions (1) and (2) are satisfied. In other words, the operation of the robot arm 22 is permitted only when the opening/closing detection section 43 detects that the opening/closing door 42 is in the closed state and the operator, for example, visually confirms that the opening/closing door 42 is in the closed state, that is, when the double check is completed. As a result, erroneous recognition of the open/closed state caused by human error (for example, erroneous recognition due to the operator's mistake), machine error (for example, malfunction or failure of the opening/closing detection section 43), or system error (for example, malfunction or failure of the opening/closing signal acquisition section 31 or the opening/closing signal transmission section 44) can be effectively prevented, and the robot arm 22 can be operated with high safety.

When the determination section 33 determines that the safety confirmation state is not achieved (safety unconfirmed state), the notification signal output section 35 generates a signal for notifying that safety confirmation state is not achieved. Specifically, the notification signal output section 35 generates and outputs a signal for the notification section 37 to notify a pattern indicating that the safety confirmation state is not achieved (safety unconfirmed state).

The notification section 37 operates according to a signal output from the notification signal output section 35.

As illustrated in FIG. 4, in the present embodiment, the notification section 37 is configured with a so-called 7-segment lamp provided on the outer surface of the robot control apparatus 3, and notifies that the safety confirmation state is not achieved by a lighting pattern of each lamp. As a result, the operator can recognize that the safety confirmation state is not achieved (safety unconfirmed state). The configuration is not limited to the above configuration, and the notification section 37 may have the same configuration as the display section 50, or may have a configuration in which the notification is performed by turning on or blinking a light emitting element by a single color or multi-color LED, a configuration in which the notification is performed by voice, or a configuration in which these are combined.

The notification section 37 can display numbers, alphabets, symbols, and the like according to the lighting pattern of each segment lamp. In the example illustrated in FIG. 4, the notification section 37 displays a symbol and a number of “-50-” in combination. The pattern of “-50-” indicates that the opening/closing door 42 is in the open state. As a result, the operator can recognize that the cause of the safety confirmation state not being achieved is the open state of the opening/closing door 42, and can close the opening/closing door 42 or confirm the opening or closing of the opening/closing door 42.

When the pattern of “-70-” is displayed on the notification section 37, the opening/closing door 42 is in the closed state, but this indicates that the trigger signal acquisition section 32 did not receive the safety confirmation signal (trigger signal). As a result, the operator can perform the safety confirmation, input information indicating that the safety confirmation is completed to the transmission apparatus 5, and transmit the safety confirmation signal to the robot control apparatus 3.

When the pattern of “-30-” is displayed on the notification section 37, it is indicated that the opening/closing door 42 is in the open state and the transmission of the safety confirmation signal (trigger signal) is not performed by the operator. As a result, the operator can set the opening/closing door 42 to the closed state, perform the safety confirmation, input information indicating that the safety confirmation is completed to the transmission apparatus 5, and transmit the safety confirmation signal to the robot control apparatus 3.

Further, in the present embodiment, the notification section 37 can also notify (display) that the safety confirmation state is achieved. When the pattern of “-00-” is displayed on the notification section 37, the opening/closing door 42 is in the closed state, but this indicates that the trigger signal acquisition section 32 received the safety confirmation signal (trigger signal). As a result, it can be understood that the operation of the robot arm 22 is permitted.

The relationship between what kind of error the pattern displayed on the notification section 37 indicates, that is, the fact that the safety unconfirmed state is achieved and the cause thereof, and the displayed pattern, is already known, and the operator recognizes this. Therefore, by visually recognizing the pattern displayed on the notification section 37, the operator can easily recognize what kind of error occurred in the robot system 1.

As described above, the fact that the safety confirmation state is not achieved (safety unconfirmed state) can be notified by the pattern displayed on the notification section 37. Further, the fact that the safety confirmation state is not achieved, the cause of the safety confirmation state not being achieved, that is, which of the above conditions (1) and (2) is not satisfied can be notified by the pattern displayed on the notification section 37. As a result, the operator can easily recognize the cause of the safety confirmation state, and can appropriately and quickly take measures to eliminate the cause.

Another configuration example of the notification section 37 will be described. The notification section 37 includes three types of light emitting elements of blue, yellow, and red, and when the safety confirmation state is achieved, all the light emitting elements are turned off. When the cause of the safety confirmation state not being achieved is that the opening/closing signal cannot be acquired from the safety fence system 4, the yellow light emitting element blinks. When the cause of the safety confirmation state not being achieved is that the opening/closing door 42 is in the open state, the yellow light emitting element is turned on. When the cause of the safety confirmation state not being achieved is that the safety confirmation signal is not received, the blue light emitting element is turned on.

In addition, when the notification section 37 has a configuration including four light emitting elements of green, blue, yellow, and red, the control may be performed as follows. First, when the safety confirmation state is achieved, the green light emitting element blinks. After the operation permission of the robot arm 22, the green light emitting element is turned on. When the cause of the safety confirmation state not being achieved is that the opening/closing signal cannot be acquired from the safety fence system 4, the yellow light emitting element blinks. When the cause of the safety confirmation state not being achieved is that the opening/closing door 42 is in the open state, the yellow light emitting element is turned on. When the cause of the safety confirmation state not being achieved is that the safety confirmation signal is not received, the blue light emitting element is turned on.

In addition, in a configuration in which the notification section 37 performs notification by voice, the notification section 37 performs notification of whether the safety confirmation state or the safety unconfirmed state is achieved by voice, and in the safety unconfirmed state, the notification section 37 can further notify the cause by voice. As a cause, a voice such as “the opening/closing door is not closed” or “the safety confirmation signal cannot be received” is emitted. With the notification section 37 having such a configuration, the fact that the safety confirmation state is not achieved and the cause of the safety confirmation state not being achieved can be notified.

The storage section 36 stores a program or the like for executing the control operation performed by each of the above-described functional sections.

Each functional section of the robot control apparatus 3, the safety fence system 4, and the transmission apparatus 5 can be realized by a hardware configuration example as illustrated in FIG. 3. The robot control apparatus 3, the safety fence system 4, and the transmission apparatus 5 each include at least one processor, a memory, and an I/O interface. The control section, the storage section, and the communication section are coupled to each other to be able to communicate with each other, for example, via a bus.

Here, the safety fence system 4 may be configured to be able to transmit a signal indicating the open state or the closed state of the opening/closing door 42, and may be configured to include a physical switch that is electrically coupled to the robot control apparatus 3 without including a processor, for example.

The processor is configured with, for example, a central processing unit (CPU), and reads out and executes various programs stored in the memory. The processor is an example of the control section.

The memory stores various programs executed by the processor and the like. Examples of the memory include a configuration having a volatile memory such as a random access memory (RAM), a non-volatile memory such as a read only memory (ROM), a detachable external storage device, and the like. The memory is an example of a storage section. In addition, the storage section is not limited to this configuration, and may be mounted by a relay circuit that is switched according to the state.

The I/O interface corresponds to a communication unit such as a wired local area network (LAN) or a wireless LAN. As a result, signals can be transmitted and received between the robot control apparatus 3, the safety fence system 4, and the transmission apparatus 5, or between the robot control apparatus 3, the safety fence system 4, and the transmission apparatus 5, and the external devices. The transmission and reception of the signal may be performed via a server (not illustrated), or may be performed via a network such as the Internet. The I/O interface is an example of a communication section.

As described above, the robot control apparatus 3 is a robot control apparatus that outputs the drive signal to the robot 2 having the robot arm 22 and controls the operation of the robot 2, the robot control apparatus including: the opening/closing signal acquisition section 31 that acquires the opening/closing signal including information on the open/closed state of the opening/closing door 42 as an opening/closing section that opens or closes the access section 45 configured to access the movable region A of the robot 2; the trigger signal acquisition section 32 that acquires the safety confirmation signal (trigger signal); and the determination section 33 that defines, as a safety confirmation state, a case where, when power is supplied to the robot control apparatus 3, the opening/closing detection section 43 detects that the closed state is achieved based on the opening/closing signal acquired by the opening/closing signal acquisition section 31, and the trigger signal acquisition section 32 acquires the trigger signal, and determines whether or not the safety confirmation state is achieved, in which the operation of the robot arm 22 is permitted when the determination section 33 determines that the safety confirmation state is achieved, and the operation of the robot arm 22 is prohibited when the determination section 33 determines that the safety confirmation state is not achieved. Accordingly, the robot arm 22 can be configured to be permitted to operate only when confirmation of the closed state of the opening/closing section (opening/closing door 42) is completed both via the opening/closing signal acquisition section 31 and via the trigger signal acquisition section 32. Therefore, erroneous recognition of the open/closed state caused by human error, machine error, or system error can be effectively prevented, and the robot arm 22 can be operated with high safety.

Further, the robot control system 100 includes: the opening/closing door 42 as the opening/closing section that opens or closes the access section 45 that is configured to access the movable region A of the robot 2 having the robot arm 22; the opening/closing detection section 43 that detects the open state or the closed state of the opening/closing door 42; the opening/closing signal transmission section 44 that transmits the opening/closing signal including the information on the open/closed state detected by the opening/closing detection section 43; and the robot control apparatus 3 that outputs the drive signal to the robot 2 to control the operation of the robot 2. In addition, the robot control apparatus 3 includes: the opening/closing signal acquisition section 31 that acquires the opening/closing signal; the trigger signal acquisition section 32 that acquires the safety confirmation signal (trigger signal); and the determination section 33 that defines, as a safety confirmation state, a case where when power is supplied to the robot control apparatus 3, the opening/closing detection section 43 detects that the closed state is achieved based on the opening/closing signal acquired by the opening/closing signal acquisition section 31, and the trigger signal acquisition section 32 acquires the safety confirmation signal, and determines whether or not the safety confirmation state is achieved, and the robot control apparatus 3 permits the operation of the robot arm 22 when the determination section 33 determines that the safety confirmation state is achieved, and prohibits the operation of the robot arm 22 when the determination section 33 determines that the safety confirmation state is not achieved. Accordingly, the robot arm 22 can be configured to be permitted to operate only when confirmation of the closed state of the opening/closing section (opening/closing door 42) is completed both via the opening/closing signal acquisition section 31 and via the trigger signal acquisition section 32. Therefore, erroneous recognition of the open/closed state caused by human error, machine error, or system error can be effectively prevented, and the robot arm 22 can be operated with high safety.

In the present embodiment, a case where the trigger signal is the safety confirmation signal input by the operator using the transmission apparatus 5 was described as an example, but the present disclosure is not limited thereto, and the trigger signal may be a signal (a signal indicating that the entering object is absent) output by the entering object detection sensor 6 described in the third embodiment.

In the present embodiment, a configuration in which the drive control section 34 permits or prohibits the operation of the robot arm 22 is described, but the present disclosure is not limited thereto, and a configuration in which a functional section other than the drive control section 34 permits or prohibits the operation of the robot arm 22 by switching the supply and interruption of power to the robot 2 may be adopted.

Further, as described above, the robot control apparatus 3 includes the notification section 37 that notifies that the safety confirmation state is not achieved when the determination section 33 determines that the safety confirmation state is not achieved (safety unconfirmed state). As a result, the operator can recognize that the safety confirmation state is not achieved, and can take a subsequent measure.

The robot control apparatus 3 may not include the notification section 37. In this case, the fact that the safety confirmation state is not achieved by a device other than the robot control apparatus 3, for example, the transmission apparatus 5 may be notified.

Further, the notification section 37 notifies that the safety confirmation state is not achieved (safety unconfirmed state) together with the cause of the safety confirmation state not being achieved. As a result, the operator can recognize the cause of the safety confirmation state, and can appropriately and quickly take measures to eliminate the cause.

The configuration is not limited to the above configuration, and the notification section 37 may be configured to omit the notification of the cause of the safety confirmation state not being achieved and to notify only that the safety confirmation state is not achieved.

Next, an example of the control method of the present disclosure will be described with reference to the flowchart illustrated in FIG. 5.

First, in step S101, the power supply is turned on. That is, the power switch (not illustrated) is turned on to supply power from the external power supply to the robot control apparatus 3.

Next, in step S102, it is determined whether or not the opening/closing signal is acquired. That is, the opening/closing signal acquisition section 31 determines whether or not the opening/closing signal is acquired. In step S102, when it is determined that the opening/closing signal is acquired (step S102: YES), the process proceeds to step S103, and when it is determined that the opening/closing signal is not acquired in step S102 (step S102: NO), the process proceeds to step S106.

In step S103, it is determined whether or not the closed state is achieved. That is, it is determined whether or not the acquired opening/closing signal includes the information on the closed state. In step S103, when it is determined that the closed state is achieved (step S103: YES), the process proceeds to step S104, and when it is determined that the closed state is not achieved in step S103 (step S103: NO), the process proceeds to step S106.

In step S104, it is determined whether or not the trigger signal, which is the safety confirmation signal, is acquired. That is, the trigger signal acquisition section 32 determines whether or not the trigger signal is acquired. In step S104, when it is determined that the trigger signal is acquired (step S104: YES), the process proceeds to step S105, and when it is determined that the trigger signal is not acquired in step S104 (step S104: NO), the process proceeds to step S106.

Such steps S102, S103, and S104 are a first step of determining whether or not the safety confirmation state is achieved. Steps S102, S103, and S104 are executed by the determination section 33. When the results in all of steps S102, S103, and S104 are YES, it is determined that the safety confirmation state is achieved, and in step S105, the operation of the robot arm 22 is permitted.

Meanwhile, when the results in one or more of step S102, step S103, and step S104 are NO, the operation of the robot arm 22 is prohibited in step S106.

Such steps S105 and S106 are a second step of permitting the operation of the robot arm 22 when the determination section 33 determines that the safety confirmation state is achieved, and prohibiting the operation of the robot arm 22 when the determination section 33 determines that the safety confirmation state is not achieved.

After step S106, in step S107, notification is performed by the notification section 37. The content of the notification is that the safety unconfirmed state is achieved and the cause thereof. Step S107 is executed by the notification signal output section 35 and the notification section 37 as described above.

Although not illustrated, after step S105, in step S107, a notification that the safety confirmation state is achieved may be performed.

After step S107 is executed, the process returns to step S102, and the subsequent steps are sequentially executed.

As described above, the control method according to the present disclosure is a control method of the robot control apparatus 3 that includes the opening/closing signal acquisition section 31 that acquires the opening/closing signal including information on the open/closed state of the opening/closing door 42 as the opening/closing section that opens or closes the access section 45 configured to access the movable region A of the robot 2 having the robot arm 22, and the trigger signal acquisition section 32 that acquires the trigger signal, and that outputs the drive signal to the robot 2 to control the operation of the robot 2, the method including: a first step of defining, as a safety confirmation state, a case where, when power is supplied to the robot control apparatus 3, the opening/closing detection section 43 detects that the closed state is achieved based on the opening/closing signal acquired by the opening/closing signal acquisition section 31, and the trigger signal acquisition section 32 acquires the trigger signal, and determining whether or not the safety confirmation state is achieved; and a second step of permitting the operation of the robot arm 22 when it is determined that the safety confirmation state is achieved, and prohibiting the operation of the robot arm 22 when it is determined that the safety confirmation state is not achieved in the first step. Accordingly, the robot arm 22 can be configured to be permitted to operate only when confirmation of the closed state of the opening/closing section (opening/closing door 42) is completed both via the opening/closing signal acquisition section 31 and via the trigger signal acquisition section 32. Therefore, erroneous recognition of the open/closed state caused by human error, machine error, or system error can be effectively prevented, and the robot arm 22 can be operated with high safety.

The present disclosure is not limited to the configuration in which step S102, step S103, and step S104 are executed in this order, and for example, step S104, step S102, and step S103 may be executed in this order.

### Second Embodiment

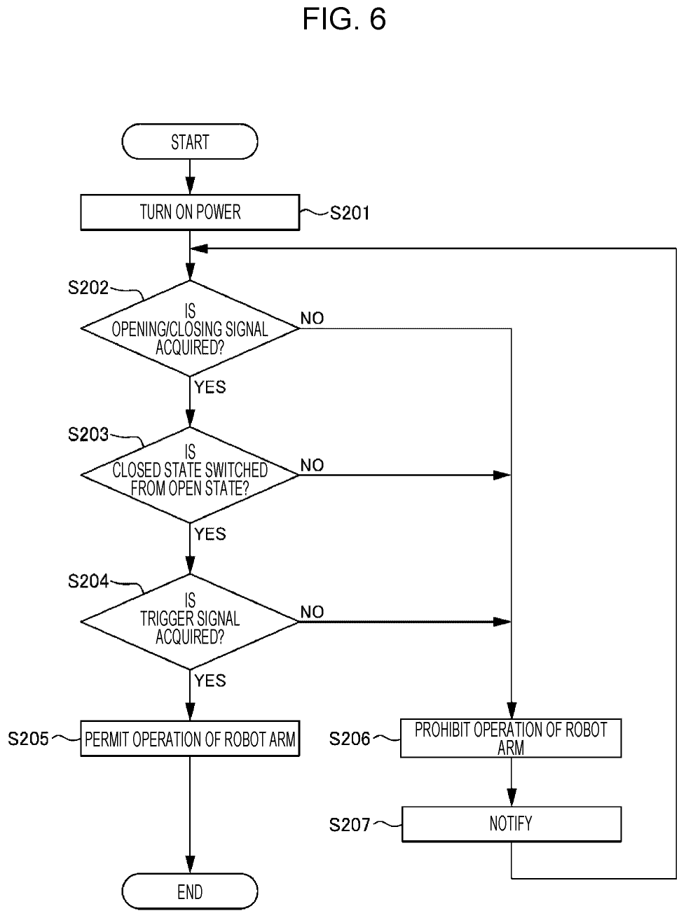

FIG. 6 is a flowchart for describing an example of the control method according to a second embodiment of the present disclosure.

Hereinafter, the robot control system, the robot control apparatus, and the control method according to the second embodiment of the present disclosure will be described with reference to FIG. 6. In the following, mainly differences from the first embodiment will be described, and description of common points will be omitted.

In the present embodiment, the determination section 33 determines whether or not the safety confirmation state is achieved by determining whether or not the following conditions (1A) and (2) are satisfied when the power is supplied to the robot control apparatus 3.

Condition (1A): The opening/closing detection section 43 detects that the open state is changed to the closed state based on the opening/closing signal acquired by the opening/closing signal acquisition section 31. The fact that the condition (1A) is satisfied means that the opening/closing signal includes information that the open state is switched to the closed state. When the condition (1A) is satisfied, it is confirmed that the opening/closing door 42 is switched from the open state to the closed state, and it can be considered that the operator performs the work of closing the opening/closing door 42.

Condition (2): The trigger signal acquisition section 32 acquired the safety confirmation signal (trigger signal). The fact that the condition (2) is satisfied means that the operator, for example, visually confirms that the opening/closing door 42 is in the closed state, inputs the fact, and transmits the fact. The condition (2) is the same as that of the first embodiment.

The determination section 33 determines that the “safety confirmation state” is achieved when both the conditions (1A) and (2) are satisfied, and determines that the “safety unconfirmed state” is achieved when at least one of the conditions (1A) and (2) is not satisfied.

According to the condition (1A), when the power is supplied to the robot control apparatus 3 and the opening/closing door 42 is in the closed state, the operator needs to execute the work of opening and closing the opening/closing door 42 again after opening the opening/closing door 42 once. In executing this work, the operator is prompted to visually confirm the safety in the movable region A of the robot 2. Therefore, the robot arm 22 can be operated with higher safety.

As described above, in the present embodiment, a state where it is confirmed that the opening/closing door 42 is switched from the open state to the closed state, and a state where the operator confirms that the opening/closing door 42 is in the closed state by visual confirmation or the like are set as the safety confirmation state. When the determination section 33 determines that the safety confirmation state is achieved, the operation of the robot arm 22 is permitted. Accordingly, the robot arm 22 is configured to be permitted to operate only when confirmation of the closed state is completed both via the opening/closing signal acquisition section 31 and via the trigger signal acquisition section 32. In particular, since it can be confirmed that the opening/closing door 42 is switched from the open state to the closed state, the robot arm 22 can be operated with higher safety.

As illustrated in FIG. 6, the control method of the present embodiment includes steps S201, S202, S203, S204, S205, S206, and S207. Since steps S201, S202, S204, S205, S206, and S207 are the same as steps S101, S102, S104, S105, S106, and S107 in the first embodiment, the description thereof will be omitted, and step S203 will be described.

In step S203, it is determined whether or not the information that the open state is switched to the closed state is included in the opening/closing signal acquired by the opening/closing signal acquisition section 31 in step S202. In step S203, when it is determined that the information that the opening/closing signal is switched from the open state to the closed state is included, the process proceeds to step S204. In step S203, when it is determined that the information that the opening/closing signal is switched from the open state to the closed state is not included, the process proceeds to step S206.

Although not illustrated in FIG. 6, after step S205, in step S207, a notification that the safety confirmation state is achieved may be performed.

As described above, when the opening/closing signal indicating that the opening/closing door 42 as the opening/closing section is switched from the open state to the closed state is received, the determination section 33 detects that the opening/closing door 42 is in the closed state. As a result, it can be confirmed that the opening/closing door 42 is switched from the open state to the closed state, and thus the robot arm 22 can be operated with higher safety.

Even when the opening/closing signal indicating the open state and the opening/closing signal indicating the closed state are sequentially received, these two opening/closing signals can be regarded as opening/closing signals indicating that the open state is switched to the closed state.

As described above, in the present embodiment, when the power is supplied to the robot control apparatus 3, and the opening/closing signal indicating that the open state is switched to the closed state is received, the determination section 33 determines that the safety confirmation state is achieved. As a result, the robot arm 22 can be operated with higher safety.

### Third Embodiment

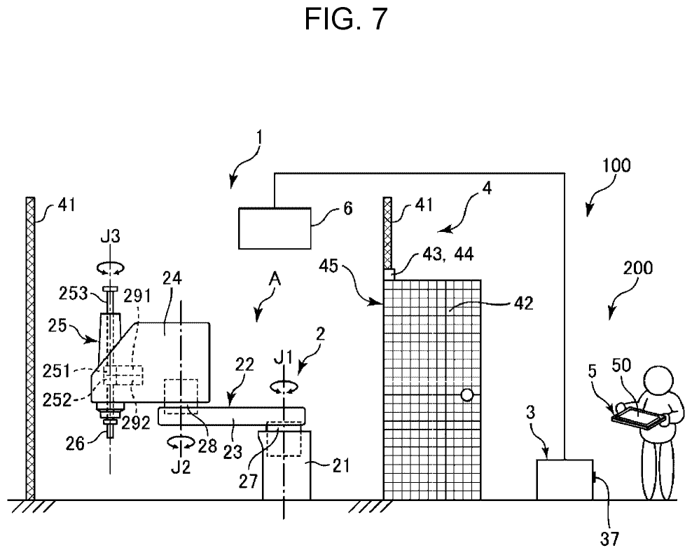

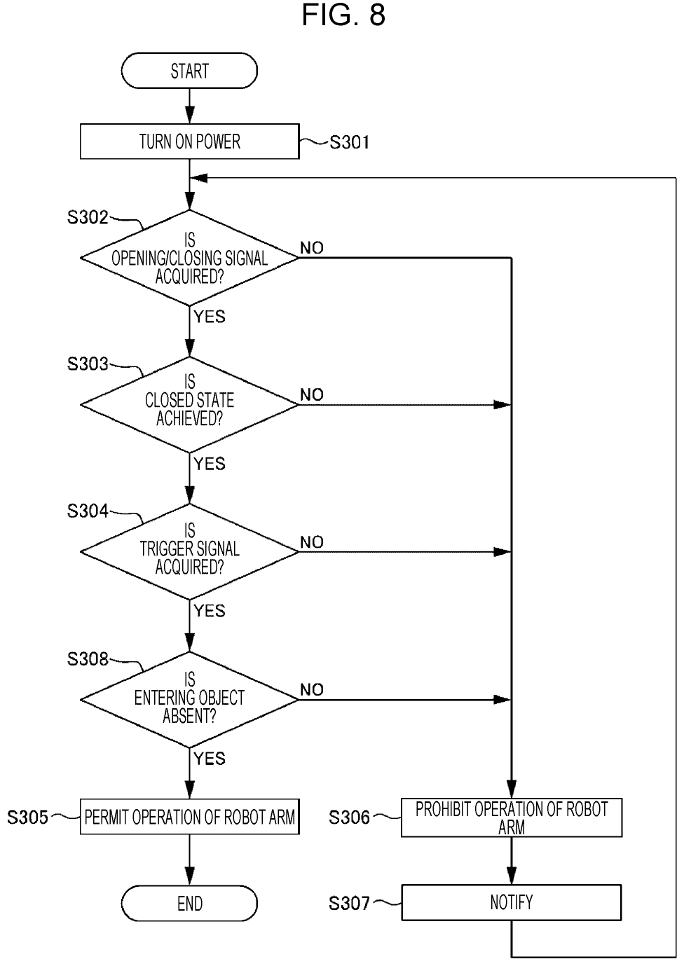

FIG. 7 is a schematic configuration diagram of the robot system including the robot control apparatus and the robot control system according to the third embodiment of the present disclosure. FIG. 8 is a flowchart for describing an example of the control method according to the third embodiment of the present disclosure.

Hereinafter, the robot control system, the robot control apparatus, and the control method according to the third embodiment of the present disclosure will be described with reference to FIGS. 7 and 8. In the following, mainly differences from the first embodiment will be described, and description of common points will be omitted.

As illustrated in FIG. 7, the robot system 1 includes the entering object detection sensor 6 that detects the entering object in the movable region A. The entering object detection sensor 6 is configured by, for example, various image recognition devices (cameras), various contact (touch) sensors, various optical sensors, various magnetic sensors, various electrostatic capacitive sensors, or a combination of two or more of these. The entering object detection sensor 6 is electrically coupled to the robot control apparatus 3, and the detection value detected by the entering object detection sensor 6 is transmitted to the robot control apparatus 3 as an electric signal, and is acquired by the trigger signal acquisition section 32.

An electric signal (hereinafter referred to as a “sensor signal”) of a detection value detected by the entering object detection sensor 6 is included in the trigger signal. That is, the trigger signal includes the safety confirmation signal described in the first embodiment and the sensor signal.

The sensor signal may be a signal after the presence or absence of the entering object is determined, or may be a signal before the presence or absence of the entering object is determined. That is, the configuration may be such that the entering object detection sensor 6 determines the presence or absence of the entering object, or the configuration may be such that the robot control apparatus 3 determines the presence or absence of the entering object.

The determination section 33 determines whether or not the safety confirmation state is achieved when the power is supplied to the robot control apparatus 3. The safety confirmation state is a state where the following conditions (1), (2), and (3) are satisfied.

Condition (1): The opening/closing detection section 43 detects that the closed state is achieved based on the opening/closing signal acquired by the opening/closing signal acquisition section 31. This is the same as in the first embodiment.

Condition (2): The trigger signal acquisition section 32 acquired the safety confirmation signal (trigger signal) from the transmission apparatus 5. This is the same as in the first embodiment.

Condition (3): The entering object is absent in the determination result of the presence or absence of the entering object based on the sensor signal.

The determination section 33 determines that the “safety confirmation state” is achieved when all of the conditions (1), (2), and (3) are satisfied, and determines that the “safety unconfirmed state” is achieved when at least one of the conditions (1), (2), and (3) is not satisfied.

As described above, when the power switch is turned on, the robot control apparatus 3 permits the operation of the robot arm 22 only when all of the conditions (1), (2), and (3) are satisfied. In other words, the operation of the robot arm 22 is permitted only when the opening/closing detection section 43 detects that the opening/closing door 42 is in the closed state, the operator, for example, visually confirms that the opening/closing door 42 is in the closed state, and further confirms that the entering object is absent based on the sensor signal of the entering object detection sensor 6, that is, when the triple check is completed. Accordingly, erroneous recognition of the open/closed state caused by human error, machine error, or system error can be effectively prevented, and the robot arm 22 can be operated with higher safety.

In particular, even when the entering object enters the movable region A suddenly in a state where the conditions (1) and (2) are satisfied, the operation of the robot arm 22 is not permitted, and thus high safety can be ensured.

As described above, the determination section 33 defines, as a safety confirmation state, a case where, when power is supplied to the robot control apparatus 3, the opening/closing detection section 43 detects that the closed state is achieved, the trigger signal acquisition section 32 acquires the safety confirmation signal as the trigger signal, and it is determined that the entering object is absent based on the signal transmitted from the entering object detection sensor 6 that detects the entering object entering the movable region A. As a result, the robot arm 22 can be operated after further confirming that the entering object is absent in the movable region A. Therefore, the robot arm 22 can be operated with higher safety.

As illustrated in FIG. 8, the control method of the present embodiment includes steps S301, S302, S303, S304, S305, S306, S307, and S308. Since steps S301, S302, S303, S304, S305, and S306 are the same as steps S101, S102, S103, S104, S105, and S106 in the first embodiment, the description thereof will be omitted, and steps S307 and S308 will be described.

Step S308 is executed by the determination section 33 when it is determined that the trigger signal is acquired in step S304 (S304: YES).

In step S308, the presence or absence of an entering object in the movable region A is determined based on the sensor signal, which is the signal transmitted from the entering object detection sensor 6. In step S308, when it is determined that an entering object is absent, the process proceeds to step S305, and when it is determined that an entering object is present in step S308, the process proceeds to step S306.

As described above, in the control method of the present embodiment, the robot arm 22 can be operated after further confirming that the entering object is absent in the movable region A. Therefore, the robot arm 22 can be operated with higher safety.

After step S306, step S307 is executed. In step S307, the notification section 37 performs notification. The content of the notification is that the safety unconfirmed state is achieved, that is, at least one of the conditions (1), (2), and (3) is not satisfied, and the cause of the content. As in the first embodiment, the cause of the safety unconfirmed state is that the condition (1) is not satisfied, the condition (2) is not satisfied, and the condition (3) is not satisfied, that is, the entering of the entering object into the movable region A.

Step S307 is executed by the notification signal output section 35 and the notification section 37 in the same manner as in the first embodiment.

Further, although not illustrated in FIG. 8, after step S305, in step S307, a notification that the safety confirmation state is achieved may be performed.

In the present embodiment, the detection (confirmation) of the presence or absence of the entering object in the movable region A may be performed at a predetermined time, for example, at any stage of before the operation disclosure of the robot arm 22, at the start of the operation, and during the operation, or may be performed at any time.

In the present embodiment, step S303 may be the same as step S203 of the second embodiment.

### Fourth Embodiment

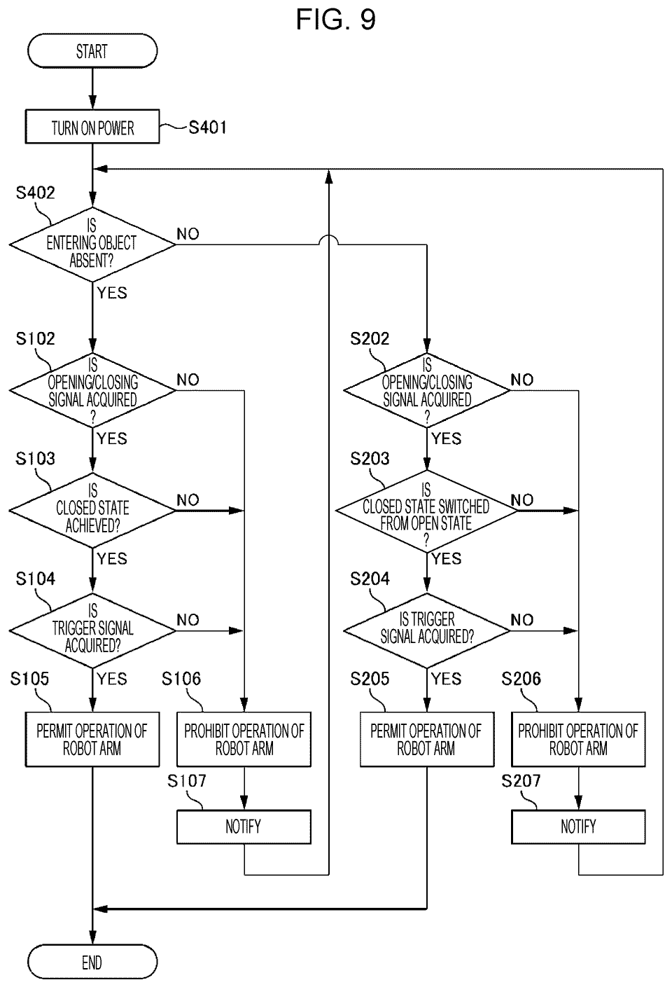

FIG. 9 is a flowchart for describing an example of the control method according to a fourth embodiment of the present disclosure.

Hereinafter, the robot control system, the robot control apparatus, and the control method according to the fourth embodiment of the present disclosure will be described with reference to FIG. 9. In the following, mainly differences from the first embodiment will be described, and description of common points will be omitted.

The present embodiment has the same system configuration as the third embodiment, and includes the robot 2, the robot control apparatus 3, the safety fence system 4, the transmission apparatus 5, and the entering object detection sensor 6, as illustrated in FIG. 7.

In the present embodiment, the first embodiment is different in that the method of performing the safety confirmation differs depending on the result detected by the entering object detection sensor 6 when the power switch is turned on.

As illustrated in FIG. 9, the control method of the present embodiment includes steps S401, S402, S102, S103, S104, S202, S203, S204, S105, S106, S107, S205, S206, and S207. Since step S401 is the same as step S101 in the first embodiment, the description thereof will be omitted, and step S402 will be described.

In step S402, the presence or absence of an entering object in the movable region A is determined based on the sensor signal, which is the signal transmitted from the entering object detection sensor 6. In step S402, when it is determined that the entering object is absent, the process proceeds to step S102, and then the same control operation as in the first embodiment is executed until the process proceeds to step S105 or step S107. In step S402, when it is determined that the entering object is present, the process proceeds to step S202, and then the same control operation as in the second embodiment is executed until the process proceeds to step S205 or step S207.

In other words, in the present embodiment, when it is determined that the entering object is absent in step S402, the control operation (S102 to S107) of the first embodiment is executed. That is, the operation of the robot arm 22 is permitted only when the conditions (1) and (2) are satisfied. Meanwhile, when it is determined that the entering object is present in step S402, the control operation (S202 to S207) of the second embodiment is executed. That is, the operation of the robot arm 22 is permitted only when the conditions (1A) and (2) are satisfied. By selecting whether to use the conditions (1) and (2) as the determination reference or to use the conditions (1A) and (2) as the determination reference depending on the presence or absence of the entering object, when the entering object is present, the operator can be effectively prompted to visually confirm the safety in the movable region A of the robot 2.

As described above, in the control method of the present embodiment, when an entering object is present in the movable region A, in order to permit the operation of the robot arm 22, the opening/closing signal needs to satisfy the condition (1A) that the open state is switched to the closed state. Therefore, the robot arm 22 can be operated with higher safety as compared with a case where the entering object is absent in the movable region A. Further, by changing the condition for permitting the operation of the robot arm 22 in accordance with the presence or absence of the entering object in the movable region A, the convenience of the operator can be improved.

Above, the robot control system, the robot control apparatus, and the control method of the present disclosure were described with reference to each of the embodiments illustrated in the drawings, but the present disclosure is not limited thereto. In addition, each section and each step of the robot control system, the robot control apparatus, and the control method can be replaced with any structure and step that can exhibit the same function. Furthermore, any structure or step may be added.

The robot control apparatus may be above to perform an operation of invalidating a step of permitting the operation of the robot arm when the determination section determines that the safety confirmation state is achieved, and performing an operation of invalidating a step of prohibiting the operation of the robot arm when the determination section determines that the safety confirmation state is not achieved.

In addition, when the safety fence system is provided with a light curtain, a photoelectric sensor, and a laser range sensor, which are examples of an entering object detection sensor, instead of the opening/closing door, the determination section may determine that the safety confirmation state is achieved when both the conditions (2) and (3) are satisfied.

1. A robot control system comprising:
an opening/closing section that opens or closes an access section configured to access a movable region of a robot having a robot arm;
an opening/closing detection section that detects an open state or a closed state of the opening/closing section;
an opening/closing signal transmission section that transmits an opening/closing signal including information on the open/closed state detected by the opening/closing detection section; and
a robot control apparatus that outputs a drive signal to the robot and controls an operation of the robot, wherein
the robot control apparatus includes
an opening/closing signal acquisition section that acquires the opening/closing signal,
a trigger signal acquisition section that acquires a trigger signal, and
a determination section that defines, as a safety confirmation state, a case where, when power is supplied to the robot control apparatus, the opening/closing detection section detects that the closed state is achieved based on the opening/closing signal acquired by the opening/closing signal acquisition section, and the trigger signal acquisition section acquires the trigger signal, and determines whether or not the safety confirmation state is achieved, and
the robot control apparatus permits an operation of the robot arm when the determination section determines that the safety confirmation state is achieved, and prohibits an operation of the robot arm when the determination section determines that the safety confirmation state is not achieved.

2. The robot control system according to claim 1, wherein
when the opening/closing signal indicating that the opening/closing section is switched from the open state to the closed state is received, the determination section detects that the closed state is achieved.

3. The robot control system according to claim 1, wherein
the determination section defines, as the safety confirmation state, a case where, when power is supplied to the robot control apparatus, the opening/closing detection section detects that the closed state is achieved, the trigger signal acquisition section acquires a safety confirmation signal as the trigger signal, and it is determined that an entering object is absent based on a signal transmitted from an entering object detection sensor that detects the entering object entering the movable region.

4. The robot control system according to claim 1, wherein
the robot control apparatus further includes a notification section that notifies that the safety confirmation state is not achieved when the determination section determines that the safety confirmation state is not achieved.

5. The robot control system according to claim 4, wherein the notification section notifies that the safety confirmation state is not achieved and a cause of the safety confirmation state not being achieved.

6. A robot control apparatus that outputs a drive signal to a robot having a robot arm and controls an operation of the robot, the robot control apparatus comprising:
an opening/closing signal acquisition section that acquires an opening/closing signal including information on an open/closed state of an opening/closing section that opens or closes an access section configured to access a movable region of the robot;
a trigger signal acquisition section that acquires a trigger signal; and
a determination section that defines, as a safety confirmation state, a case where, when power is supplied to the robot control apparatus, an opening/closing detection section detects that the closed state is achieved based on the opening/closing signal acquired by the opening/closing signal acquisition section, and the trigger signal acquisition section acquires the trigger signal, and determines whether or not the safety confirmation state is achieved, wherein
an operation of the robot arm is permitted when the determination section determines that the safety confirmation state is achieved, and an operation of the robot arm is prohibited when the determination section determines that the safety confirmation state is not achieved.

7. A control method of a robot control apparatus that includes an opening/closing signal acquisition section that acquires an opening/closing signal including information on an open/closed state of an opening/closing section that opens or closes an access section configured to access a movable region of a robot having a robot arm, and a trigger signal acquisition section that acquires a trigger signal, and that outputs a drive signal to the robot to control an operation of the robot, the method comprising:
a first step of defining, as a safety confirmation state, a case where, when power is supplied to the robot control apparatus, an opening/closing detection section detects that the closed state is achieved based on the opening/closing signal acquired by the opening/closing signal acquisition section, and the trigger signal acquisition section acquires the trigger signal, and determining whether or not the safety confirmation state is achieved; and
a second step of permitting an operation of the robot arm when it is determined that the safety confirmation state is achieved, and prohibiting an operation of the robot arm when it is determined that the safety confirmation state is not achieved in the first step.
